(19) United States
(12) Patent Application Publication
(10) Pub. No.: US 2016/0045963 A1
(43) Pub. Date: Feb. 18, 2016

(54) TRANSMISSION MECHANISM OF A FRET SAWING MACHINE

(71) Applicant: Chiung-Yu Chang, Taichung (TW)

(72) Inventor: Chiung-Yu Chang, Taichung (TW)

(21) Appl. No.: 14/664,230

(22) Filed: Mar. 20, 2015

(30) Foreign Application Priority Data
Aug. 13, 2014 (TW) 103214400

(51) Int. Cl. B23D 51/14; B23D 51/16

(52) U.S. Cl. CPC B23D 51/14; B23D 51/16

(57) ABSTRACT

A transmission mechanism of a fret sawing machine includes a saw frame provided thereon with two parallel transmission units, and a fretsaw connected between the two transmission units. Each transmission unit consists of a driving rod, which has one end connected with a power unit and another end extending radially to form an eccentric portion. A connecting rod is pivotally connected with the eccentric portion, having another end pivotally connected with a sliding block that is connected with a fretsaw. Thus, the driving rod can drive the sliding block to carry out linear reciprocating motion and actuate the fretsaw to do sawing work.

### BACKGROUND OF THE INVENTION

1. Field of the Invention

This invention relates to a fret sawing machine, particularly to a transmission mechanism of a fret sawing machine.

2. Description of the Prior Art

A transmission mechanism of a conventional fret sawing machine, as shown in FIGS. 1 and 2, includes a base 1 provided thereon with a pair of parallel swinging arm 2 respectively provided at an intermediate portion with a pivot 3 to be pivotally fixed with the base 1 so that the swinging arms 2, with the pivot 3 serving as a central axis, can carry out pivotal rotation relative to the base 1. Further, the two swinging arms 2 have one end mutually connected with a connecting rod 4 to enable the two swinging arms 2 to move together at the same time and another end respectively mounted with a clamping member 5, with the two clamping members 5 mutually connecting a fretsaw 6 therebetween. Furthermore, the base 1 is installed with a motor 7 having its output shaft eccentrically and pivotally disposed with an eccentric rod 8, which has another end pivotally connected with one of the two swinging arms 2. Thus, as shown in FIG. 2, the motor 7 can simultaneously drive the two swinging arms 2 to carry out up-and-down reciprocating swing for actuating the fretsaw 6 to produce up-and-down sawing action.

However, referring to FIG. 2, since the swinging arms 2 of the conventional fret sawing machine are fixed in length; therefore, when the swinging arms 2 are driven to swing with the pivots 3 serving as central axis like a seesaw, the motion path of the clamping member 5 is an arc line and as a result, when carrying out up-and-down sawing, the fretsaw 6 will shift and deflect forward and backward so a user can hardly control the position of the fretsaw 6 for carrying out sawing work precisely. In view of the above-mentioned drawback, the inventor of this invention thinks that the conventional fret sawing machine is necessary to be ameliorated and hence devises this invention.

### SUMMARY OF THE INVENTION

This invention is devised to offer a transmission mechanism of a fret sawing machine, able to drive a fretsaw to carry out up-and-down linear sawing motion and get rid of the drawback that the fretsaw of a conventional fret sawing machine is likely to swing bias and thus able to carry out sawing work precisely.

The transmission mechanism of a fret sawing machine in the present invention includes a machine table having a base provided thereon with a workbench, which is bored with an insert hole. The base is assembled thereon with a saw frame provided with two parallel fixed arms, which are respectively positioned at opposite two sides of the workbench and have their ends respectively formed with a sliding groove. A power unit is combined with the machine table for power output, and two transmission units are respectively assembled with the two fixed arms. Each transmission unit is provided with a driving rod, which is pivotally combined with the fixed arm and has one end connected with the power unit and another end stretching radially to form an eccentric portion. Each transmission unit is further provided with a connecting rod having one end pivotally connected with the eccentric portion, and a sliding block slidably positioned in the sliding groove and pivotally connected with another end of the connecting rod. Two clamping units are respectively fixed with the sliding blocks and a fretsaw is inserted through the insert hole of the workbench and has two ends respectively connected with the two clamping units.

The transmission mechanism of a fret sawing machine of this invention has one end of the connecting rod pivotally connected with the eccentric portion and positioned eccentrically with the driving rod, and another end pivotally connected with the sliding block that is slidably mounted in the sliding groove. Therefore, when the power unit is started to actuate the driving rod to rotate, the connecting rod will be driven by the eccentric portion to rotate around the driving rod and actuate the sliding block to carry out linear reciprocating motion along the sliding groove and simultaneously, the sliding block will actuate the fretsaw to carry out up-and-down linear sawing motion. By so designing, this invention can effectively eliminate the defect that the fretsaw of a conventional fret sawing machine is likely to swing bias during sawing and hence is able to carry out sawing work precisely.

### BRIEF DESCRIPTION OF DRAWINGS

This invention will be better understood by referring to the accompanying drawings, wherein:

FIG. 1 is a schematic view of a transmission mechanism of a conventional fret sawing machine;

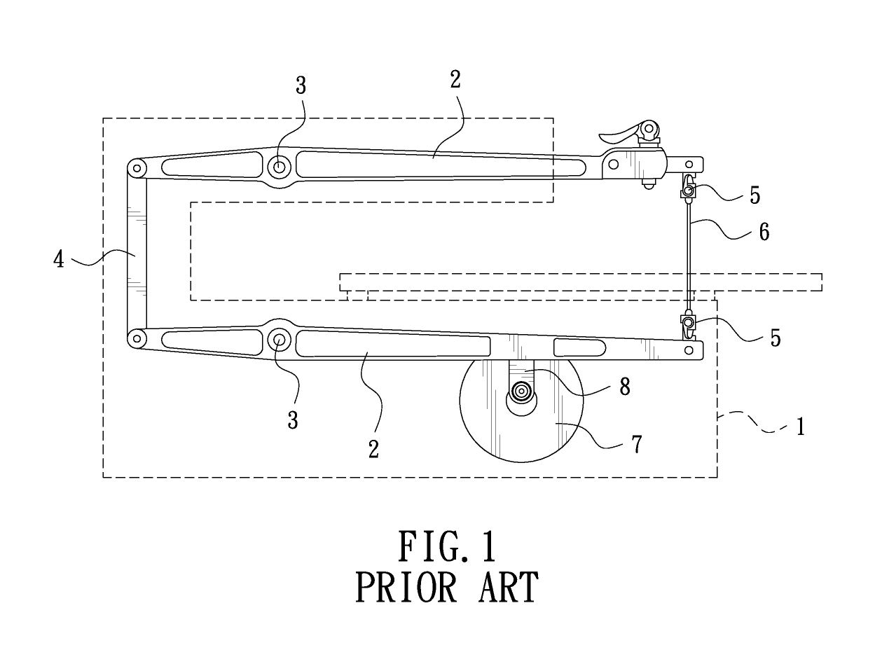

FIG. 2 is a schematic view of the transmission mechanism of the conventional fret sawing machine in action;

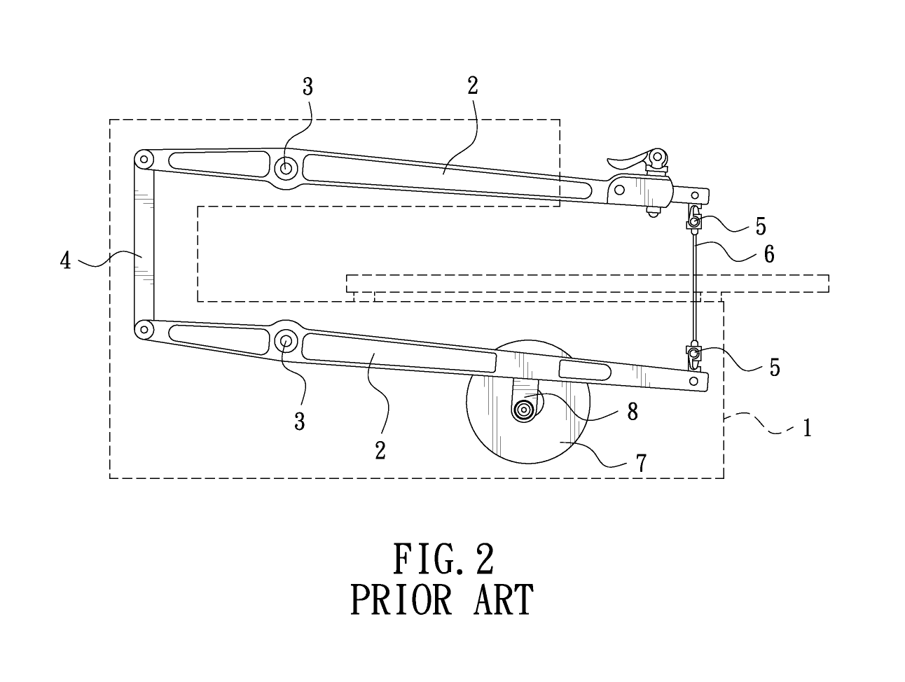

FIG. 3 is a perspective view of a fret sawing machine in the present invention;

FIG. 4 is a cross-sectional view of the fret sawing machine in the present invention;

FIG. 5 is an exploded perspective view of a transmission unit in the present invention;

FIG. 6 is an exploded perspective view of a clamping unit in the present invention;

FIG. 7 is a first schematic view of the transmission unit in action in the present invention;

FIG. 8 is a second schematic view of the transmission unit in action in the present invention;

FIG. 9 is a third schematic view of the transmission unit in action in the present invention;

FIG. 10 is a first schematic view of the clamping unit in action in the present invention;

FIG. 11 is a second schematic view of the clamping unit in action in the present invention; and

FIG. 12 is a schematic view of a saw frame in action in the present invention.

### DETAILED DESCRIPTION OF THE PREFERRED EMBODIMENT

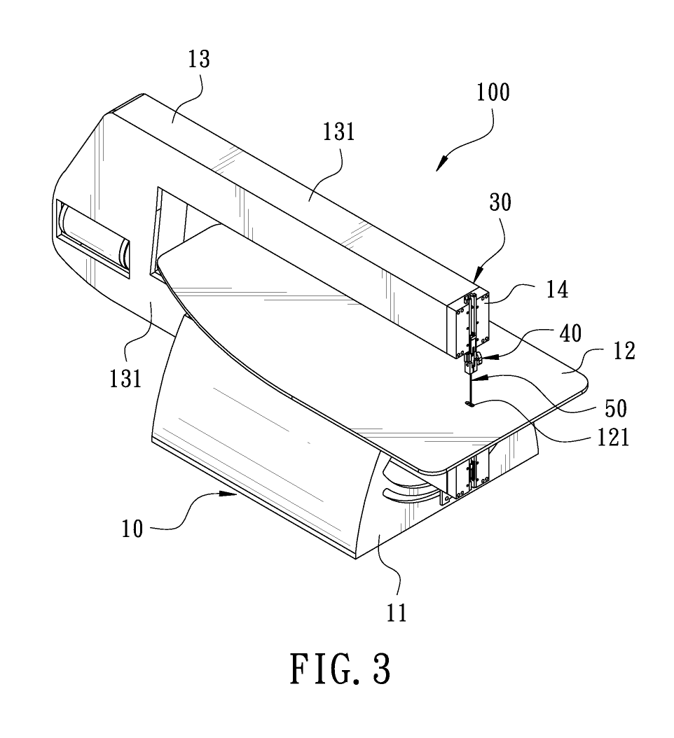

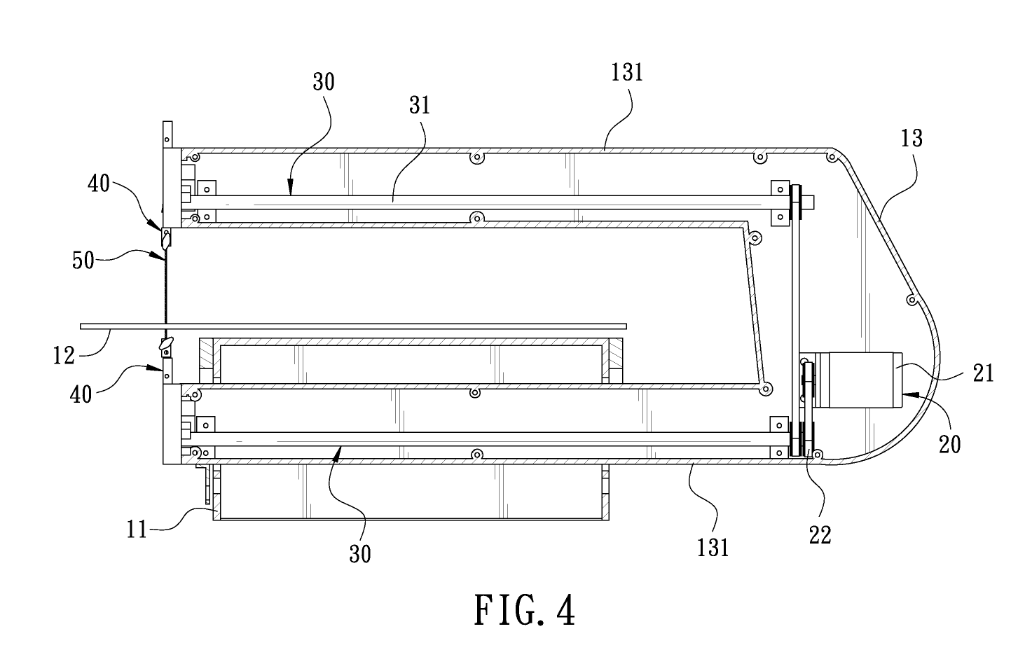

A preferred embodiment of a transmission mechanism 100 of a fret sawing machine in the present invention, as shown in FIGS. 3 and 4, includes a machine table 10, a power unit 20 and two transmission units 30 as main components combined together.

The machine table 10 has a base 11 provided thereon with a workbench 12 with an insert hole 121 and the base 11 is further pivotally disposed with a saw frame 13, which is formed with two parallel fixed arms 131 respectively positioned at opposite two sides of the workbench 12. The two fixed arms 131 have their ends respectively secured with a fixing seat 14, which has an outer side provided with a sliding groove 141 and an inner side bored with an engraved hole 142 communicating with the sliding groove 141, and two inner walls formed by the sliding groove 141 are respectively provided with a positioning groove 143.

The power unit 20 is set with the machine table 10 for power output. In this preferred embodiment, the power unit 20 is positioned in the saw frame 13 and provided with a motor 21 that is connected with a belt pulley unit 22.

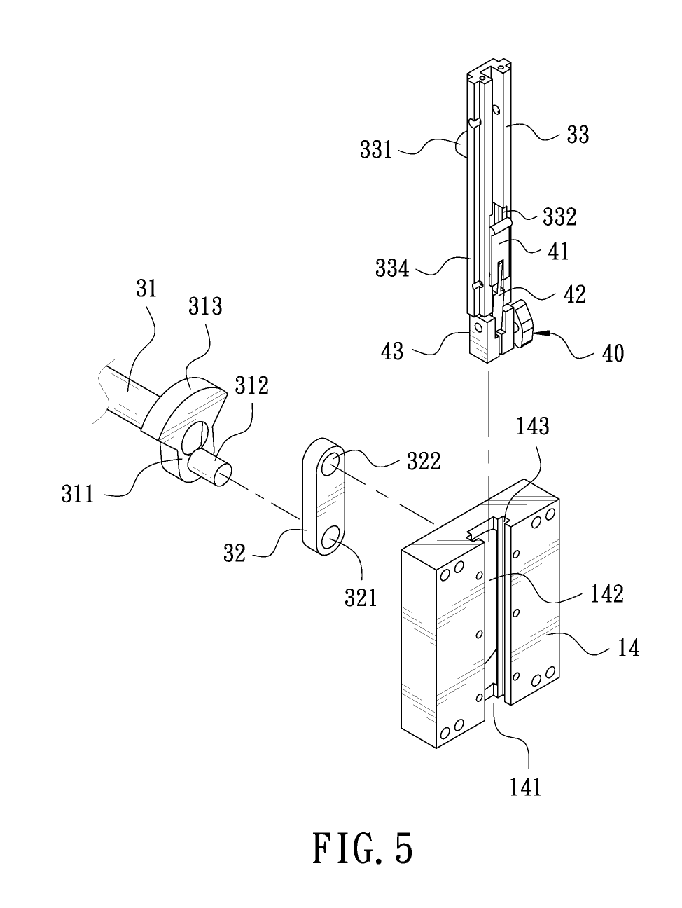

The two transmission units 30 are respectively combined with the two fixed arms 131 and, referring to FIG. 5, each transmission unit 30 is composed of a driving rod 31, a connecting rod 32 and a sliding block 33.

The driving rod 31 is pivotally assembled with the fixed arm 131, having one end connected with the belt pulley unit 22 and the power unit 20 and another end extending radially to form an eccentric portion 311 having a pivotal post 312 disposed thereon. Further, the driving rod 31 is provided with a counter weight member 313 at one end where the eccentric portion 311 is formed. In this preferred embodiment, the counter weight member 313 is a sector protruding block that is provided reversely to the eccentric portion 311.

The connecting rod 32 to be received in the engraved hole 142 has one end formed with a pivotal hole 321 corresponding to the pivotal post 312 so that the pivotal post 312 can be inserted in the pivotal hole 321 for pivotally connecting the eccentric portion 311 with the connecting rod 32, and the connecting rod 32 has another end bored with a connecting hole 322.

The sliding block 33 to be slidably received in the sliding groove 141 is provided with a connecting post 331 corresponding to the connecting hole 322 of the connecting rod 32 for the connecting post 331 to be inserted in the connecting hole 322 for pivotally connecting the connecting rod 32 with the sliding block 33. The sliding block 33 is further bored with an accommodating groove 332 and two slots 333, and has two sides respectively formed with a positioning projections 334 to be slidably fitted in the positioning groove 143 of the fixing seat 14 for elevating the stability of the sliding block 33 when the sliding block 33 slides in the sliding groove 141.

The transmission mechanism of a fret sawing machine in the present invention further includes two clamping units 40 and a fretsaw 50.

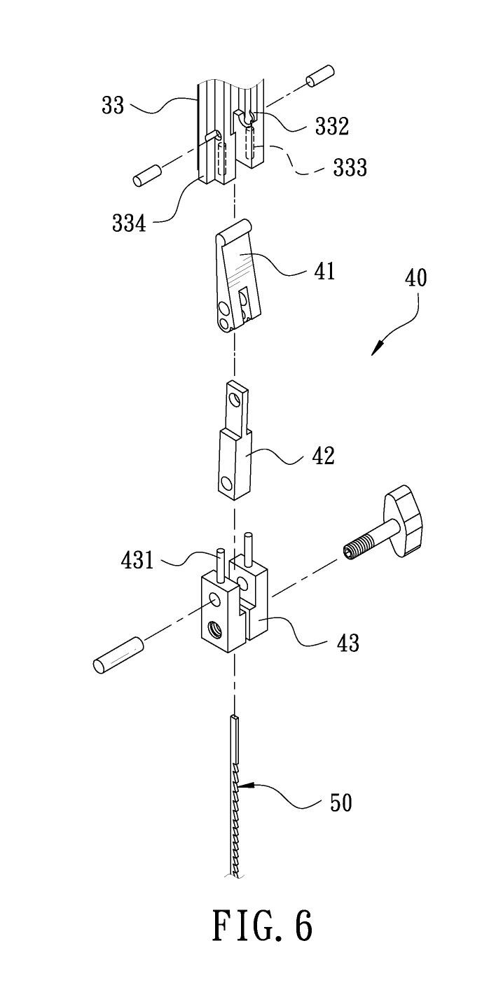

The two clamping units 40 are respectively combined with the sliding blocks 33. In this preferred embodiment, referring to FIG. 6, each clamping unit 40 consists of a pull handle 41 to be pivotally received in the accommodating groove 332 of the sliding block 33, and the pull handle 41 is eccentrically and pivotally provided with a connecting piece 42, which has another end pivotally provided with a clamping block 43 formed thereon with two protruding posts 431 corresponding to the two slots 333 to have the two protruding posts 431 respectively inserted in the two slots 333 to enable the clamping block 43 to be slidably fixed with the sliding block 33.

The fretsaw 50 is inserted through the insert hole 121 of the workbench 12, having two ends respectively connected with the two clamping units 40. In this preferred embodiment, the fretsaw 50 has two ends respectively clamped by the clamping blocks 43.

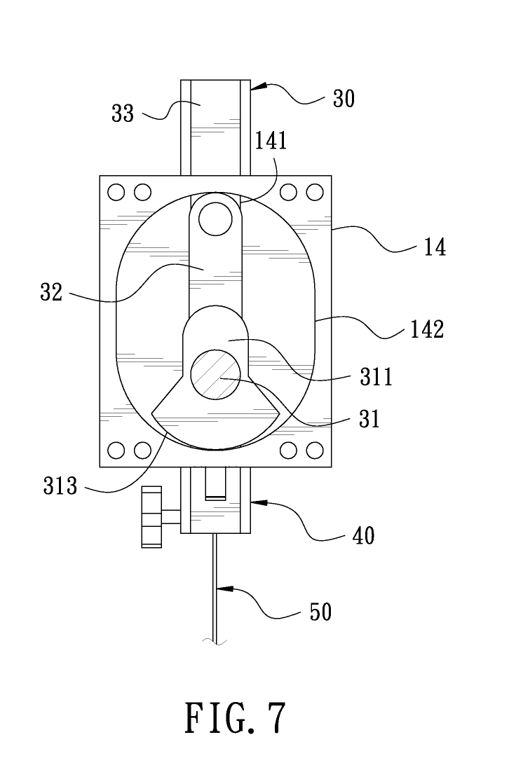

In operating, referring to FIGS. 7, 8 and 9, when the power unit 20 is started, the motor 21 will immediately drive the belt pulley unit 22 to rotate and actuate the driving rod 31 of the transmission unit 30 to rotate synchronously. At this time, since the connecting rod 32 has one end pivotally combined with eccentric portion 311 and eccentrically positioned with the driving rod 31 and another end pivotally fixed with the sliding block 33, which is slidably positioned in the sliding groove 141 of the fixing seat 14 and which can only slide along the sliding groove 141; therefore, when the driving rod 31 begins to rotate, the connecting rod 32 will be driven by the eccentric portion 311 to carry out rotary motion around the driving rod 31 and actuate the sliding block 33 to carry out linear reciprocating motion along the sliding groove 141, letting the fretsaw 50 move together with the sliding block 33 and carry out up-and-down linear sawing action. Thus, this invention can get rid of the defect that the fretsaw of a conventional fret sawing machine is likely to swing bias when carrying out sawing and hence can carry out sawing work precisely.

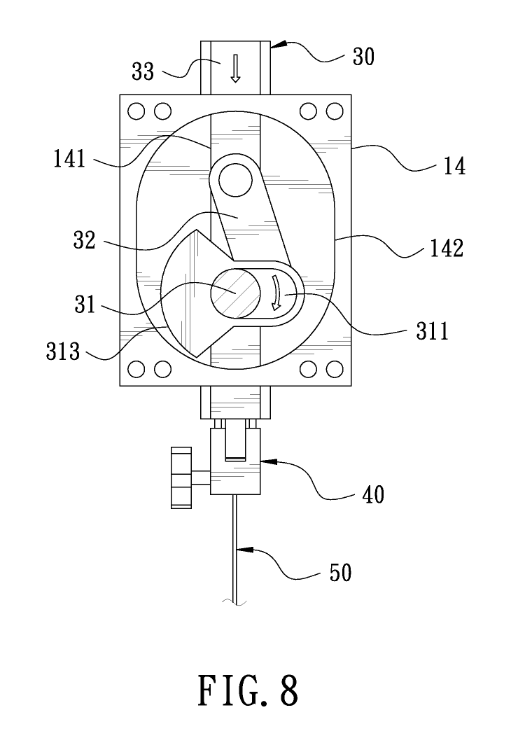

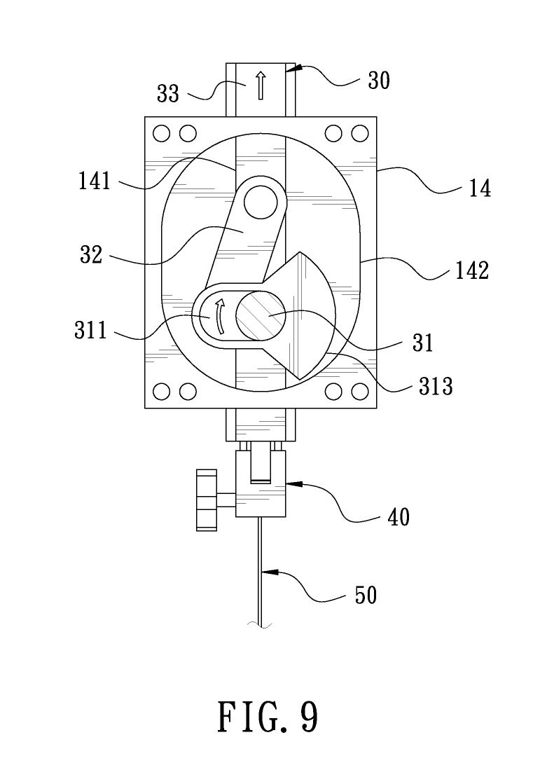

One of the special features of this invention is that in the course of the driving rod 31 driving the sliding block 33 to carry out linear reciprocating motion along the sliding groove 141 and when the driving rod 31 actuates the sliding block 33 to move downward, the counter weight member 313 will be turned to the upper side of the driving rod 31, as shown in FIG. 8, and when the driving rod 31 drives the sliding block 33 to slide upward, the counter weight member 313 will be turned to the lower side of the driving rod 31, as shown in FIG. 9. Thus, the kinetic energy of the sliding block 33 can be balanced via the counter weight member 313 for producing an effect of dynamic equilibrium, letting the sliding block 33 slide comparatively smoothly.

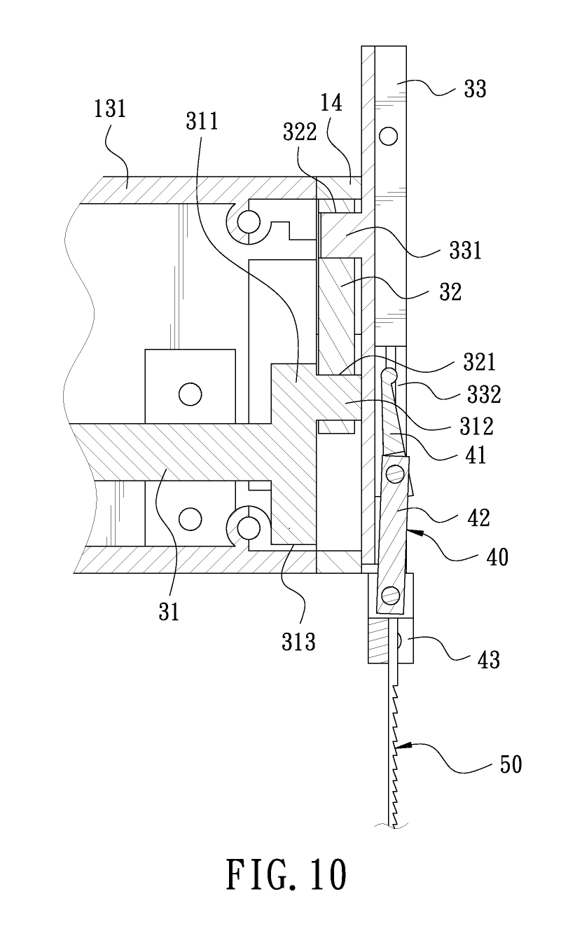

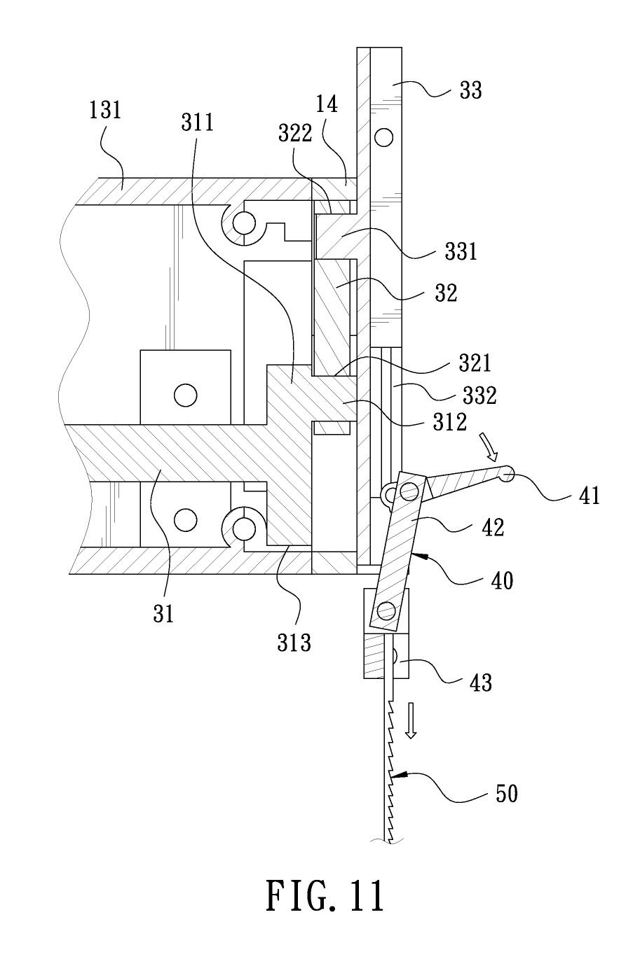

Referring to FIGS. 10 and 11, since the pull handle 41 is eccentrically and pivotally provided with the connecting piece 42; therefore, to replace the fretsaw 50, only draw the pull handle 41 out of the accommodating groove 332 of the sliding block 33 to let the connecting piece 42 together with the clamping block 43 slide in the direction of the fret saw 50, thus able to release the fretsaw 50 for facilitating a user to remove and replace the fretsaw 50. After the fretsaw 50 is replaced with a new one, the pull handle 41 is again pressed in the accommodating groove 332 and meanwhile, the pull handle 41 will actuate the clamping block 43 to slide toward the sliding block 33 for stretching taut the fretsaw 50. By so designing, it is convenient for a user to replace the fretsaw 50 and by having the pull handle 41 stored in the accommodating groove 332, a user can avoid touching the pull handle 41 by mistake and releasing the fretsaw 50 accidentally.

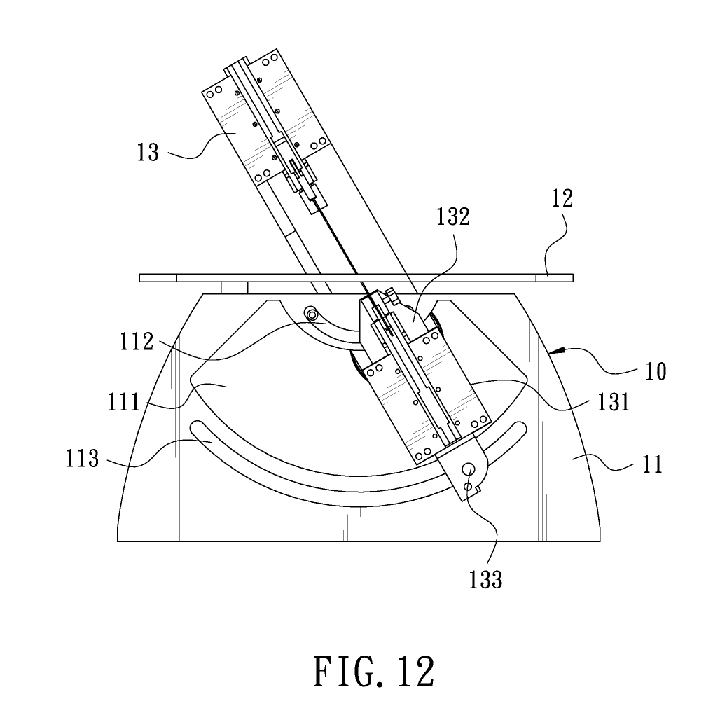

Referring to FIG. 12, the base 11 is bored with a sector hole 111 and provided with an arc-shaped frame 112 and an arc-shaped guide hole 113 at locations adjacent to the sector hole 111. One of the two fixed arms 131 of the saw frame 13 is inserted through the sector hole 111 and formed with a fixed frame 132 to be slidably fixed on the arc-shaped frame 112 and further provided with an insert pin 133 to be inserted in the arc-shaped guide hole 113. Thus, the fixed arm 131 can be guided by both the arc-shaped frame 112 and the arc-shaped hole 113 to carry out swinging, and a user can adjust the angle of the saw frame 13 relative to the workbench 12 in accordance with needs of sawing.

While the preferred embodiment of the invention has been described above, it will be recognized and understood that various modifications may be made therein and the appended claims are intended to cover all such modifications that may fall within the spirit and scope of the invention.

What is claimed is:

1. A transmission mechanism of a fret sawing machine comprising:
a machine table formed with a base, said base provided thereon with a workbench, said workbench bored with an insert hole, a saw frame mounted on said base, said saw frame provided with two parallel fixed arms, said two fixed arms respectively positioned at opposite two sides of said workbench, said fixed arms having their ends respectively formed with a sliding groove;
a power unit combined with said machine table for power output;
two transmission units respectively combined with two said fixed arms, each said transmission unit having a driving rod pivotally assembled with said fixed arm, said driving rod having one end connected with said power unit and another end extending radially to form an eccentric portion, each transmission unit further formed with a connecting rod, said connecting rod having one end pivotally connected with said eccentric portion, each said transmission unit also containing a sliding block, said sliding block slidably positioned in said sliding groove and pivotally combined with another end of said connecting rod;
two clamping units respectively mounted with said sliding blocks; and
a fretsaw inserted through said insert hole of said workbench, said fretsaw having two ends respectively connected with said clamping units.

2. The transmission mechanism of a fret sawing machine as claimed in claim 1, wherein said eccentric portion is provided thereon with a pivotal post, while said connecting rod is bored with a pivotal hole corresponding to said pivotal post for said pivotal post to be inserted therein, said eccentric portion pivotally connected with said connecting rod.

3. The transmission mechanism of a fret sawing machine as claimed in claim 1, wherein said connecting rod has another end bored with a connecting hole, and said sliding block is provided thereon with a connecting post corresponding to said connecting hole, said connecting post inserted in said connecting hole for pivotally connecting said connecting rod with said sliding block.

4. The transmission mechanism of a fret sawing machine as claimed in claim 1, wherein said fixed arm has an end secured with a fixing seat, said fixing seat having an outer side bored with a sliding groove and an inner side formed with an engraved hole communicating with said sliding groove.

5. The transmission mechanism of a fret sawing machine as claimed in claim 1, wherein said power unit is provided with a motor, said motor connected with a belt pulley unit, said driving rods connected with said belt pulley unit.

6. The transmission mechanism of a fret sawing machine as claimed in claim 1, wherein said clamping unit has a pull handle pivotally combined with said sliding block, said pull handle eccentrically and pivotally provided thereon with a connecting piece, said connecting piece having another end pivotally provided with a clamping block, said clamping block slidably combined with said sliding block.

7. The transmission mechanism of a fret sawing machine as claimed in claim 6, wherein said sliding block is formed with two slots, while said clamping block is provided with two protruding posts corresponding to said two slots, said two protruding posts respectively inserted in said two slots to let said clamping block slidably combined with said sliding block.

8. The transmission mechanism of a fret sawing machine as claimed in claim 6, wherein said sliding block is formed with an accommodating groove, and said pull handle is received in said accommodating groove.

9. The transmission mechanism of a fret sawing machine as claimed in claim 1, wherein two inner walls formed by said sliding groove are respectively disposed with a positioning groove, and said sliding block has two sides respectively provided with a positioning projection, said positioning projection slidably fixed in said positioning groove.

10. The transmission mechanism of a fret sawing machine as claimed in claim 1, wherein a counter weight member is provided at one end of said driving rod, where said eccentric portion is formed, said counter weight member and said eccentric portion provided in reverse directions.
